(19) United States
(12) Patent Application Publication
(10) Pub. No.: US 2003/0227117 A1
(43) Pub. Date: Dec. 11, 2003

(54) Anti-walkout spool bushing

(76) Inventor: Frank McCarthy, Milan, OH (US)

Correspondence Address: HARNESS, DICKEY & PIERCE, P.L.C., P.O. BOX 828, BLOOMFIELD HILLS, MI, 48303, US

(21) Appl. No.: 10/163,249

(22) Filed: Jun. 5, 2002

(51) Int. Cl. F16F 1/30; B60G 11/12

(52) U.S. Cl. 267/270; 267/269

(57) ABSTRACT

A pivot bushing that is assembled into an eye of a leaf spring includes an anti-walkout device. The anti-walkout device comprises a retaining ring molded into the elastomeric bushing which is a part of the pivot bushing. The retaining ring is larger in diameter than the eye of the spring such that any tendency of the spring to walk off the pivot bushing is resisted by the retaining ring. The retaining ring is located at only one side of the elastomeric bushing because a leaf spring always has a tendency to wave off the pivot bushing in one direction.

### FIELD OF THE INVENTION

The present invention relates to a bushing which secures a spring to a vehicle for use in suspension systems for trucks, buses, trailers and the like. More particularly, the present invention is related to an improved spring bushing which is disposed between a leaf spring and the attachment point for the leaf spring. The improved spring bushing includes an anti-walkout feature which improves the securing of the spring to the vehicle.

### BACKGROUND OF THE INVENTION

Truck, trailer and bus suspensions are commonly designed using at least a pair of leaf springs between either or both of the front and rear axles of the vehicle (the unsprung portion) and the body of the vehicle (the sprung portion). The leaf springs are normally one or more arcuately shaped steel or composite leafs that are stacked together to form the leaf spring. The axle of the vehicle is normally secured to the approximate center of the arcuate leafs with the ends of the leafs extending upwards. The upward end of one of the leafs is normally formed into a tubular section or eye which is adapted to receive a spring or spool bushing. The spring or spool bushing usually comprises an outer metal housing which is pressed into the eye of the spring, a cylindrical shaped elastomeric bushing positioned within the outer metal housing and an inner metal housing which extends through the center of the cylindrical shaped elastomeric bushing. In some applications, the cylindrical shaped elastomeric bushing is assembled directly into the eye of the spring thus eliminating the need for the outer metal.

The inner metal housing of the spring or spool bushing can be adapted to be secured directly to the vehicle using bolts or other fasteners or the inner metal housing can be designed to have a bolt extend through the inner metal to secure the end of the leaf spring to the frame or the sprung portion of the vehicle by mating with an appropriate bracket or other mounting structure.

As the vehicle travels, relative motion between the sprung and the unsprung portions of the vehicle is accommodated by the flexing of the leaf springs. The flexing of the leaf springs causes the ends of the leaf springs to pivot at each of the tubular sections or eyes which were used to secure the leaf spring to the sprung portion of the vehicle. The spring or spool bushings are used to facilitate this pivotal motion and to isolate the vehicle from shock. The cylindrical shaped elastomeric bushing located between the eye of the spring and the inner metal housing isolates the sprung portion of the vehicle from the unsprung portion of the vehicle. In certain high load applications which utilize the outer metal, the ends of the outer metal are curved over towards the inner metal in order to further encapsulate the cylindrical shaped elastomeric bushing. The curving of the ends and thus the further encapsulating of the cylindrical shaped elastomeric bushing improves the radial spring rate, it improves the axial spring rate, it improves the axial retention and it improves the durability of the bushing.

While the spring or spool bushings which include the outer metal housing are able to improve the axial retention of the assembly, the spring or spool bushings which do not include the outer metal housing, those where the cylindrical shaped elastomeric bushing is assembled directly to the eye of the spring, this improvement in axial retention is not possible. Leaf springs have a tendency to walk off of the bushing during the flexing of the suspension and the bushing. Due to the design of the suspension systems, the leaf springs always walk off the bushings in the same direction. In order to improve the durability of the spring or spool bushing and the assembly of it with the eye of the leaf spring, it would be advantageous to provide an anti-walkout device which would stop the tendency of the eye of the spring to walk out of the bushing. Because the leaf spring always walks out in a single direction, this anti-walkout device is only needed on one side of the bushing.

### SUMMARY OF THE INVENTION

The present invention provides the art with a pivot bushing which provides the necessary axial retention and thus provides the anti-walkout feature. The present invention includes an integrally molded flange on one end of the cylindrical shaped elastomeric bushing. The flange extends radially outwardly to a diameter that exceeds the inside diameter of the eye of the leaf spring. Inside the flange is a rigid member or retaining ring that is mold bonded within the flange. The inside rigid member or retaining ring is also designed to be larger in diameter than the inside diameter of the eye of the leaf spring to act as an axial retention device. The flange is provided at only one end of the cylindrical shaped elastomeric bushing due to the fact that the walkout of the eye of the leaf spring occurs in only one direction. This allows for the assembly of the bushing within the eye by the insertion of the bushing beginning with the non-flanged end. The bushing is inserted into the eye in such a manner that the flanged end will resist the tendency of the eye of the leaf spring to walk out.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a typical rear suspension for a vehicle which incorporates unique pivot bushing in accordance with the present invention;

FIG. 2 is an enlarged view showing the end of the leaf spring and the pivot bushing shown in FIG. 1;

FIG. 3 is a cross-sectional view of the pivot bushing shown in FIG. 1;

FIG. 4 is a cross-sectional view of the elastomeric bushing and inner metal housing prior to being assembled into the eye of the leaf spring.

### DETAILED DESCRIPTION OF THE PREFERRED EMBODIMENTS

The following description of the preferred embodiment(s) is merely exemplary in nature and is in no way intended to limit the invention, its application, or uses.

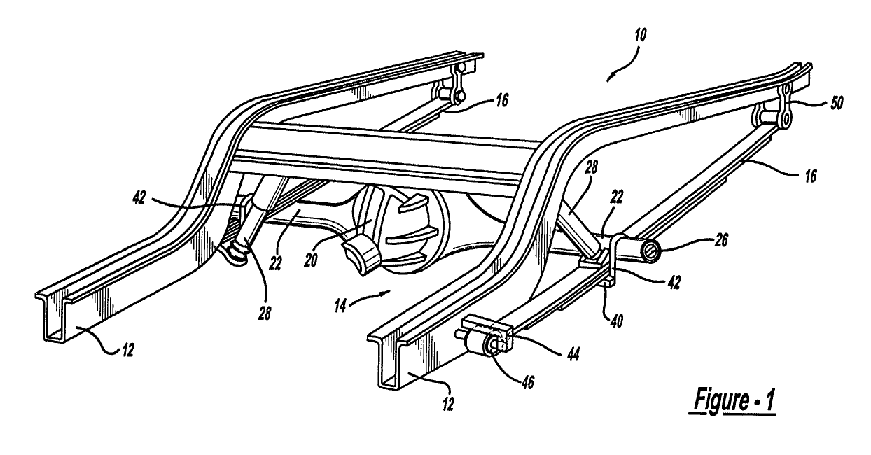

Referring now to the drawings in which like reference numerals designate like or corresponding parts throughout the several views, there is shown in FIG. 1 a truck or bus rear suspension incorporating the unique bushing in accordance with the present invention and which is designated generally by the reference numeral 10. Rear suspension 10 comprises a frame 12, a drive axle 14 and a pair of leaf springs 16. Frame 12 supports a body (not shown) and other components of the vehicle which are generally identified as the sprung portion or the sprung mass. Drive axle 14 includes a differential 20 which receives torque from an engine (not shown) through a rotating propeller shaft (not shown). Drive axle 14 also includes a pair of hollow tubes 22 that each extend out to a respective wheel assembly (not shown). Disposed within each of tubes 22 is a drive shaft 26 that extends from differential 20 to a wheel hub (not shown) to which is attached a wheel and tire (not shown). The engine transmits rotation and torque to differential 20 through the propeller shaft. Differential 20 transfers the rotation and torque from the propeller shaft to drive shafts 26 to rotate and thus drive the wheels and tires of the vehicle. Leaf springs 16 are disposed between frame 12 and drive axle 14 as will be discussed later herein. Additionally, a shock absorber 28 is disposed between each rail of frame 12 and drive axle 14 to dampen the motion between these components. A torque rod (not shown) can be disposed between frame 12 and drive axle 14 to assist in the control of the motion of the drive axle 14 with respect to frame 12, if desired.

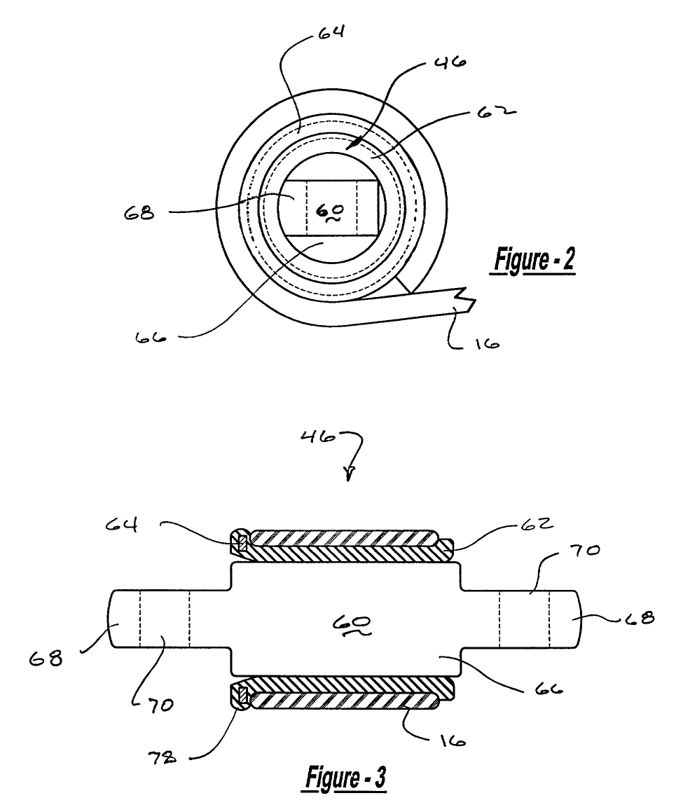

Referring now to FIGS. 1 and 2, leaf springs 16 are each attached to a respective tube 22 using a spring plate 40 and a pair of spring clips 42. The front loop of each leaf spring 16 is attached to a bracket 44 attached to frame 12. A pivot bushing 46 is disposed between leaf spring 16 and bracket 44 to accommodate motion between these two components and to isolate the vehicle from shocks. The rear loop of each leaf spring 16 is attached to a shackle 50 which is disposed between frame 12 and the rear loop of each leaf spring 16. A pivot bushing 46 can be disposed between leaf spring 16 and shackle 50 and a pivot bushing 46 can be disposed between shackle 50 and frame 12 to accommodate motion between these components and isolate the vehicle from shocks, if desired.

While the present invention is being illustrated as having only one pivot bushing 46 disposed between each leaf spring 16 and frame 12, it is within the scope of the present invention to have two, three or possibly more pivot bushings 46 disposed between leaf spring 16 and frame 12, if desired. In addition, while the present invention is being described as possibly having three identical pivot bushings 46 disposed between spring 16 and frame 12, it is within the scope of the present invention to use a different design for each pivot bushing, if desired. Finally, while the present invention is being illustrated as having shackle 50 disposed between the rear loop of leaf spring 16 and frame 12, it is within the scope of the present invention to have shackle 50 disposed between the front loop or leaf spring 16 and frame 12 or between the front and rear loops of leaf spring 16 and frame 12, if desired.

Referring now to FIGS. 2-4, pivot bushing 46 comprises an inner metal 60, an elastomeric bushing 62 and a retaining ring 64. Inner metal 60 includes a generally cylindrical center section 66 and a pair of generally rectangular sections 68, one rectangular section 68 being disposed at each end of center section 66. Each rectangular section 68 has an aperture 70 extending through it which is used to secure pivot bushing 46 to the appropriate bracket on the vehicle. While center section 66 is illustrated as a solid generally cylindrical section, it is within the scope of the present invention to utilize a tubular inner metal, if desired. If a tubular metal is used, generally rectangular sections 68 or formed from the ends of the tubular center section. Also, when a tubular section is utilized, generally rectangular sections 68 can be eliminated and a through bolt can be used to secure the pivot bushing to the frame of the vehicle.

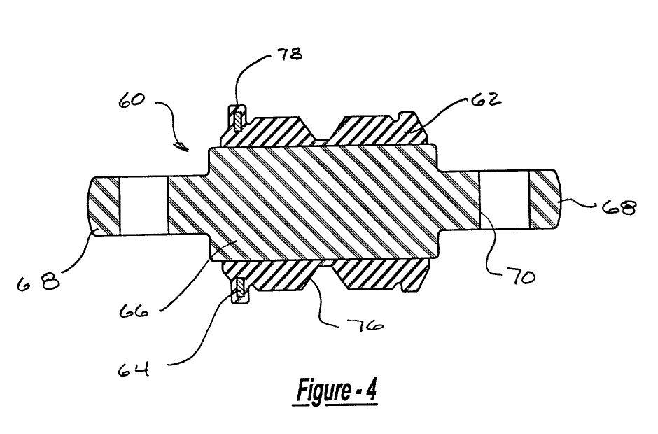

Elastomeric bushing 62 is an annular member which is located between inner metal 60 and the associated loop in the end of leaf spring 16. The diameter of elastomeric bushing 62 in its free state is larger than the space between inner metal 60 and the inside diameter of the loop on the end of leaf spring 16 such that a specified percent compression is applied to elastomeric bushing 62 when it is assembled into leaf spring 16. The assembly of pivot bushing 46 is preferably a accomplished by first bonding elastomeric bushing to inner metal 60 and then inserting this combination into the inside diameter of the eye of leaf spring 16. As shown in FIG. 4, elastomeric bushing 62 includes one or more cutout sections 76 which are used to tune elastomeric bushing 62.

Retaining ring 64 is an annular shaped ring which is mold bonded within elastomeric bushing 62 inside a flange 78 molded as an integral part of elastomeric bushing 62. The outside diameter of retaining ring 64 and thus the outside diameter of flange 78 is designed to be larger than the inside diameter of the eye of leaf spring 16. By having the diameter of retaining ring 64 larger than the inside diameter of the eye of leaf spring 16, any tendency of leaf spring 16 to walk off of pivot bushing 46 will be resisted by the contact of retaining ring 64 with the side of the eye of leaf spring 16. By encasing retaining ring 64 within flange 78 of elastomeric bushing 62, a direct metal to metal contact and thus a direct metal noise path between retaining ring 64 and the eye of leaf spring 16 is prevented.

Retaining ring 64 can be a metal or plastic washer, a metal or plastic ring or a stamping. Retaining ring 64 and flange 78 need only be incorporated on one side of elastomeric bushing 62 because leaf springs 16 always walk off of pivot bushing 46 in the same direction. Therefore, by molding retaining ring 64 into elastomeric bushing 62 and having it larger in diameter than the inside diameter of the spring eye of leaf spring 16, leaf spring 16 cannot walk off pivot bushing 46 unless elastomeric bushing 62 tears. The tear strength of the material for elastomeric bushing 62 is designed to be much higher than the axial loads in this application. Also, because retaining ring 64 and flange 78 are located on only one side of pivot bushing 46, the assembly of pivot bushing 46 into the eye of leaf spring 16 is not compromised.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A leaf spring assembly comprising:
a leaf spring having a spring eye;
an inner metal disposed within said spring eye of said spring;
an elastomeric bushing disposed between said eye of said leaf spring and said inner metal; and
a retaining ring disposed within said elastomeric bushing.

2. The assembly described in claim 1 wherein said retaining ring has a diameter greater than an inside diameter of said spring eye.

3. The assembly described in claim 2 wherein said elastomeric bushing is bonded to said inner metal.

4. The assembly described in claim 3 wherein said retaining ring is molded within said elastomeric bushing.

5. The assembly described in claim 4 wherein said retaining ring is located at one end of said elastomeric bushing.

6. The assembly described in claim 1 wherein said elastomeric bushing is bonded to said inner metal.

7. The assembly described in claim 6 wherein said retaining ring is molded within said elastomeric bushing.

8. The assembly described in claim 7 wherein said retaining ring is located at one end of said elastomeric bushing.

9. The assembly described in claim 1 wherein said retaining ring is molded within said elastomeric bushing.

10. The assembly described in claim 9 wherein said retaining ring is located at one end of said elastomeric bushing.

11. The assembly described in claim 1 wherein said retaining ring is located at one end of said elastomeric bushing.

12. A pivot bushing comprising:
an elastomeric bushing;
an inner metal disposed within said elastomeric bushing; and
a retaining ring disposed within said elastomeric bushing.

13. The pivot bushing according to claim 12 wherein said elastomeric bushing includes a body and a flange extending radially outwardly from said body, said retaining ring being disposed within said flange.

14. The assembly described in claim 13 wherein said elastomeric bushing is bonded to said inner metal.

15. The assembly described in claim 14 wherein said retaining ring is molded within said elastomeric bushing.

16. The assembly described in claim 15 wherein said retaining ring is located at one end of said elastomeric bushing.

17. The assembly described in claim 12 wherein said elastomeric bushing is bonded to said inner metal.

18. The assembly described in claim 17 wherein said retaining ring is molded within said elastomeric bushing.

19. The assembly described in claim 18 wherein said retaining ring is located at one end of said elastomeric bushing.

20. The assembly described in claim 12 wherein said retaining ring is molded within said elastomeric bushing.

21. The assembly described in claim 13 wherein said retaining ring is located at one end of said elastomeric bushing.

22. The assembly described in claim 12 wherein said retaining ring is located at one end of said elastomeric bushing.
